(19) United States
(12) Patent Application Publication
(10) Pub. No.: US 2026/0243113 A1
(43) Pub. Date: Aug. 20, 2026

(54) HANDLE ASSEMBLY COMPRISING A CLEARANCE CATCH-UP SYSTEM FOR A BUTTON

(71) Applicant: MINEBEA MITSUMI Inc., Nagano-ken (JP)

(72) Inventors: David PEDROLETTI, Pianezza (IT); Thomas PEYNOT, Pianezza (IT); Antonio ROCCI, Pianezza (IT)

(73) Assignee: MINEBEA MITSUMI Inc., Nagano-ken (JP)

(21) Appl. No.: 19/535,577

(22) Filed: Feb. 10, 2026

(30) Foreign Application Priority Data
Feb. 18, 2025 (EP) 25158563.4

(51) Int. Cl. E05B 81/76

(52) U.S. Cl. CPC E05B 81/76

(57) ABSTRACT

A handle assembly for a vehicle door includes: a structure part and a cover part arranged to be mounted on the structure part; a pushing device having a button, said button being movable between a rest position and a pressed-in position; a switching device including an actuator configured to be moved from a default position to an actuated position when the cover part is mounted in a final position on the structure part and when the button is displaced from the rest position to the pressed-in position; and a clearance catch-up system configured to displace the receiver from a retracted position, according which the switching device and the receiver are distant from the cover part mounted in the final position, to a deployed position.

### CROSS-REFERENCE TO RELATED APPLICATIONS

This application claims priority to EP 25158563.4, filed February 18, 2025, the disclosure of which is incorporated herein by reference.

### FIELD

The present disclosure relates to a handle assembly comprising a clearance catch-up system for a button.

### BACKGROUND

The statements in this section merely provide background information related to the present disclosure and may not constitute prior art.

It is known to have a handle assembly with a button to be manually actuated. The button is in a rest position in the absence of any force on it and can be pushed in a pressed-in position for actuating a switching device of the handle assembly.

The pushing device and the switching device cooperate together so as to constitute a command of the handle assembly.

The button flushes with the cover so that the user can see it and press it if needed. As the switching device includes electronics, the button can be configured according to the application to have different roles as for example opening the door or locking or unlocking the door. Other roles can also be defined.

For manufacturing said handle assembly, the command can be mounted on a cover part of the handle assembly which presents a dedicated location for receiving said command and an opening to have the button accessible from the exterior of the handle assembly.

The cover part with the command is then assembled with a structure part of the handle assembly. A first step consists in connecting the switch device by clipping its connector to a plug of the vehicle. A second step consists in inserting the cover part with the command.

Finally, a third step consists in adjusting the position of the cover part with respect to the structure part. This is done thanks to a slider screw which pulls the cover and create a sandwich to ensure the fixing of the cover part.

Although this provision is satisfactory, there are drawbacks in link with the installation of such a cover part with a command. Indeed, the operator has to handle and correctly plug the connector before mounting the cover part and adjusting it. In addition, the cover part with the command is a complex part that requires attention to be handled.

In an effort to improve the manufacturing and mounting of the handle assembly, the button can only be installed on the cover, whereas the switching device can be mounted structure part.

The operator therefore receives two pre-assembled structure part and cover part, and should not have to make additional connections. The problem with this solution is that the management of the tolerances between the button and the switching device is complex, and a significant amount of clearance is necessary to allow the assembly of the cover part without interference with the switching device fixed on the structure part.

### SUMMARY

This section provides a general summary of the disclosure and is not a comprehensive disclosure of its full scope or all of its features.

The present disclosure aims to solve all or some of the disadvantages mentioned above.

For this purpose, the present invention relates to a handle assembly, for a vehicle door, comprising a structure part and a cover part arranged to be mounted on the structure part, the handle assembly also comprising: a pushing device configured to be mounted on the cover part, said pushing device having a button arranged to be accessible from the exterior of the handle assembly through an opening of the cover part, said button being movable between a rest position and a pressed-in position; a switching device configured to be mounted on a receiver of the structure part, said switching device including an actuator configured to be moved from a default position to an actuated position when the cover part is mounted in a final position on the structure part and when the button is displaced from the rest position to the pressed-in position; and a clearance catch-up system configured to displace the receiver from a retracted position, according which the switching device and the receiver are distant from the cover part mounted in final position, to a deployed position, according which the switching device and/or the receiver cooperates with the cover part mounted in final position.

The pushing device and the switching device are two distinct elements that can be handled separately. The pushing device is mounted on the cover part and the switching device is mounted on the structure part. The structure part is part of a bracket of the vehicle door.

Thus, an operator has at his disposal on one side the structure part with the switching device already connected to a plug of the vehicle, and, on the other side, the cover part with the pushing device.

Then, the operator has to install the cover part in the final position without the need of any connection to be manually done.

The clearance catch-up system can be set in a retracted position when the cover part is being mounted in a final position. This provision enables to protect the switching device and to let a sufficient space to install the cover part.

At the end of the cover part installation in a final position, the clearance catch-up system can be moved from the retracted position to the deployed to allow the switching device and pushing to cooperate together. In other word, in deployed position, when the button is pushed it triggers the switching device.

Therefore, the clearance catch-up system enables an easy installation of the cover part in final position.

According to an aspect of the invention, the receiver is in retracted position when it remains unconstrained by the clearance catch-up system.

This provision helps the operator as he or she can be sure that the receiver is set on retracted position before handling it.

According to an aspect of the invention, the clearance catch-up system is in addition configured to maintain the cover part in final position when the receiver is in deployed position.

It appears that the clearance catch-up system has a dual purpose. When the receiver is maintained in deployed position, the cover part cannot be withdrawn from its final position.

This provision improves the reliability of the handle assembly because once the mounting is completed, all elements of the handle assembly are secured together.

According to an aspect of the invention, the clearance catch-up system comprises a slider configured to cooperate with a rail made in the structure part between a release position and a fastening position, the slider being configured to cooperate with the receiver so as to set the receiver in retracted position when the slider is in release position and so as to set the receiver being in deployed position when the slider is in fastening position.

This provision enables to displace the receiver when moving the slider. Preferably, the cover part is configured to cooperate with the slider so as to be maintained in final position by the slider when the slider is in fastening position. When the slider is in release position, the cover part can be removed or installed on the structure part in final position.

Then, the slider has a dual purpose. It not only serves as intermediate element to displace and maintain in position the receiver but also to maintain the cover part in final position.

According to an aspect of the invention, the clearance catch-up system comprises an actuating element adapted to move the slider between the release position and the fastening position. Preferably, said actuating element is a screw that is adapted to fit within a thread of the structure part and/or of the slider. The screw is arranged to cooperate with the slider so as to displace the slider along the rail. The screw extends in parallel to the rail when fitted within the thread.

According to an aspect of the invention, the slider presents a cooperation surface configured to cooperate with a complementary surface of the receiver to as to apply a force on the receiver transversally to an extension direction of the rail from the retracted position to the deployed position.

The slider creates a motion transformation as the slider can be displaced according to the rail extension direction whereas the force applied to receiver is transverse to said extension direction.

Typically, the cooperation surface presents a curved section extending according to a slope oriented transversally to said extension direction. This form biases the receiver, which is displaced from the retracted position to the deployed position.

According to an aspect of the invention, the slider presents at least one bumping surface extending transverse to the extension direction of the rail that is configured to cooperate with a hook or a cage of the cover part when the slider is in fastening position to maintain the cover part in final position.

When the slider is in a release position, the bumping surface is no more in front of the hook or cage and the cover part can be withdrawn by pulling it away transversally to the extension direction of the rail.

According to an aspect of the invention, the receiver is joined to a base section of the structure part, the receiver being movable along a bending line with respect to the base section.

The receiver is thus a moving part of the structure part with respect to the base section. The movement of the receiver is according to a bending line which implies that the receiver is able to be rotated with respect to the base section around a central axis of the bending line.

Preferably, the central axis is parallel or substantially parallel to the extension direction of the rail. Therefore, the receiver is pivoting with respect to the base section when moving between the retracted position and the deployed position.

According to an aspect of the invention, the receiver or the base section presents at least one stroke limiting rib configured to cooperate with a bearing surface of the base section or respectively with the receiver, when the receiver is in retracted position.

Preferably, the receiver is conceived so as to move in direction of direction of the base section in absence of any force applied on the receiver. The bending line is made so as to create an elastic force rotating the receiver towards the base section.

The at least one stroke limiting rib enables to stop the rotation of the receiver with respect to the base section. It defines the retracted position and also prevents the button and consequently the switching device to be pushed too far.

According to an aspect of the invention, the receiver has a body extending according to a main plane and at least one leg united with the body and extending transversally to the main plane, the at least one leg being configured to cooperate with a mounting interface of the pushing device when the receiver is in deployed position.

This means that when the receiver is on a retracted position, the at least one leg is distant from the mounting interface.

The cooperation between the at least one leg and the mounting interface is realized in such a way to align the button with the actuator for a proper functioning.

This displacement of the receiver between the retracted position and the deployed position does not risk to imply misalignment between the button and the actuator.

Indeed, as the at least one leg and is snapped on the mounting interface their respective positions are precisely set when moving the receiver from the retracted position to the deployed position.

Preferably, the at least one leg and the mounting interface are configured to be snapped together. As an example, the body presents an overall flat shape. Four legs are united with the body. There are two stroke limiting ribs which are united with the body. The stoke limiting ribs are on the opposite side of the body with respect to the legs.

In addition, the receiver includes a bridge configured to cooperate with the slider. The bridge is united with the body and is the part of the receiver in contact with the slider so that the slider moves the receiver between the retracted position and the deployed position. According to an example, the bridge is a flat part which is inclined with respect to the main plane.

With this construction it appears that the body and the bridge constitute a flexible tab movable around the central axis.

According to an aspect of the invention, the button is configured to be mounted within the mounting interface, the mounting interface being configured to cooperate with the cover part so that the button is accessible from the exterior of the handle assembly to be pushed.

The cover part presents the opening through which the button can be accessed. The mounting interface acts as a support and fixing means for the button. The mounting interface with the button mounted on it constitute a sub-assembly that is fixed to the cover part from the interior side of the cover part.

The terms “exterior” and “interior” in the present text designate the exterior of the vehicle and the interior of the vehicle or of the handle assembly. By “exterior” it is therefore meant that an element is accessible at the end of the mounting by a user from an external side of the vehicle.

Here, the mounting interface is in the interior side and is not visible for the user when the mounting of the handle assembly is complete. The user only sees and have access to the button via the opening.

Preferably, the button is mounted flush with respect to the opening. It means that the button presents and end surface for actuation that extends in the continuity of an exterior surface of the cover part or that is slightly lower or higher.

According to an aspect of the invention, the cover part presents from the exterior a concave shape and consequently from the interior side a convex shape. Such a cover part is also called a “pocket”.

According to an aspect of the invention, the receiver comprises a at least one clip configured to cooperate with a complementary part of the switching device.

This allows to easily fix the switching device on the structure part. Preferably, the switching device comprises a housing and at least one contact wire arranged to be connected to a central control system of the vehicle.

The housing comprises the actuator and the at least one contact wire is connected to the actuator and exits the housing. Said housing is designed to cooperate with the at least one clip.

Said at least one clip are linked to the body of the receiver and extends in parallel or substantially in parallel to the at least one leg on the same side of the receiver.

This construction not only enables to assure a correct alignment of the button and the actuator in final position as each elements mounted together are snapped and cooperate by complementary of form, but also it confers a solidity to the button actuator assembly.

In this way, even if the button is pressed by a user with a force that exceeds the necessary for actuation, the button and the actuator are maintained in position.

The present invention also concerns a vehicle comprising at least one handle assembly as described above.

The different aspects defined above that are not incompatible can be combined.

Further areas of applicability will become apparent from the description provided herein. It should be understood that the description and specific examples are intended for purposes of illustration only and are not intended to limit the scope of the present disclosure.

### DRAWINGS

The invention will be better understood with the aid of the detailed description that is set out below with reference to the appended drawing in which:

FIG. 1 is a side view of a handle assembly with a receiver for a switching device in the retracted position;

FIG. 2 is a side view of the handle assembly with the receiver in the deployed position;

FIG. 3 is a perspective view of the handle assembly with the receiver represented in both positions;

FIG. 4 is a detail view of the handle assembly with the receiver represented in both positions; and

FIG. 5 is an overall view of the handle assembly with the receiver in deployed position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or the elements that are fulfilling identical functions may retain the same references so as to simplify the understanding of the invention.

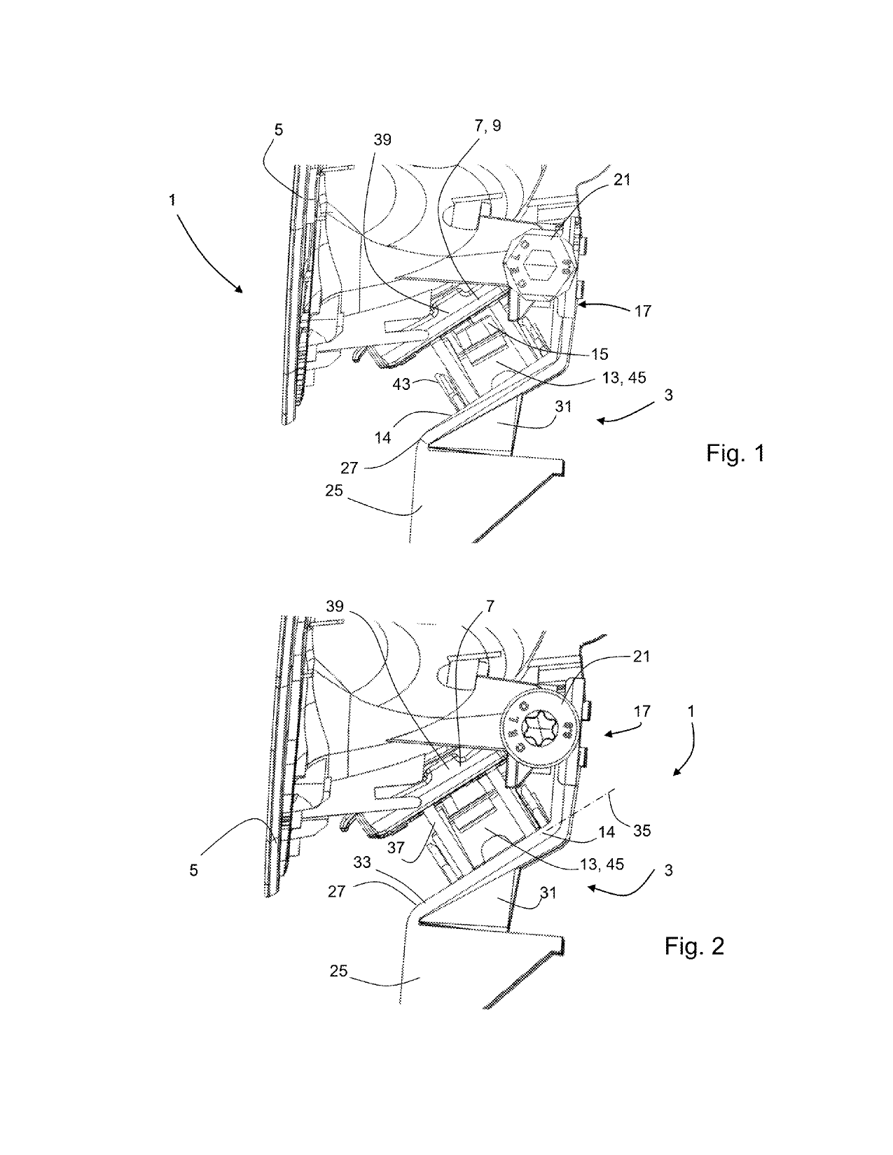

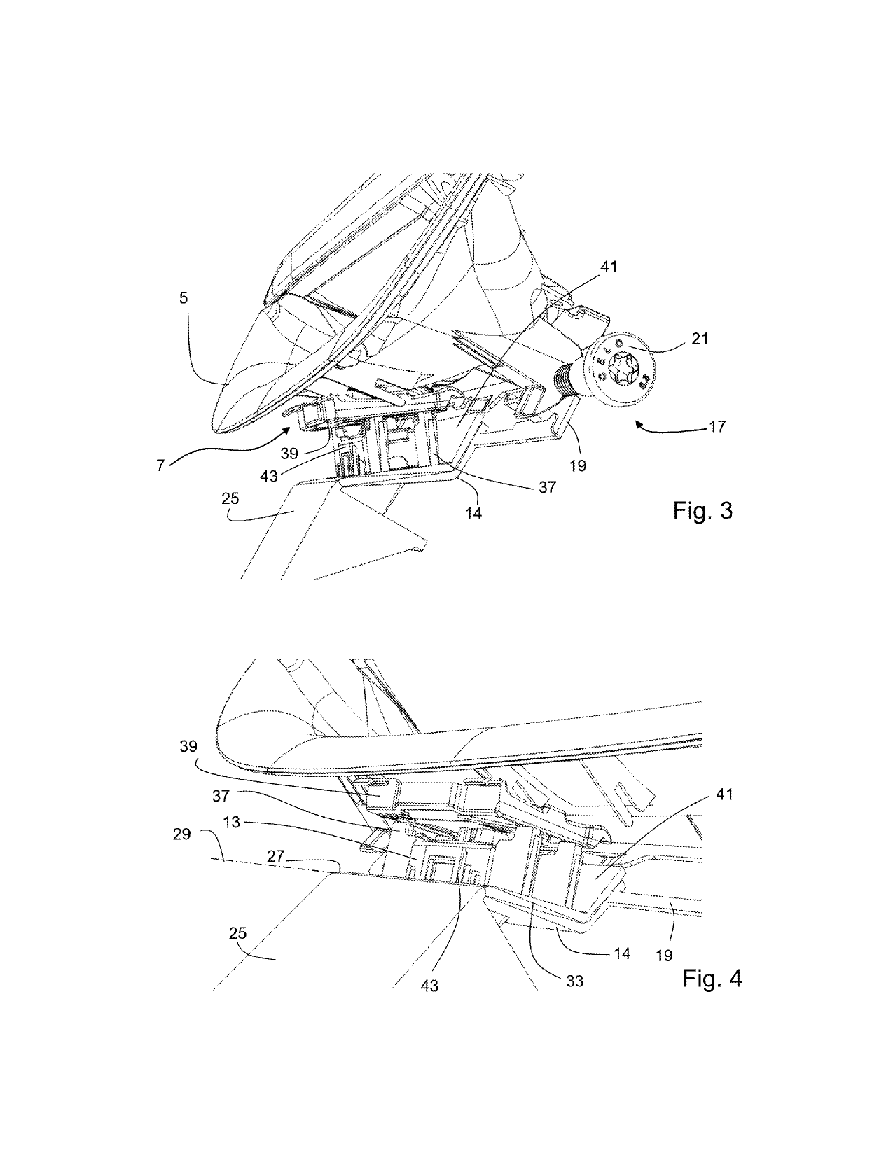

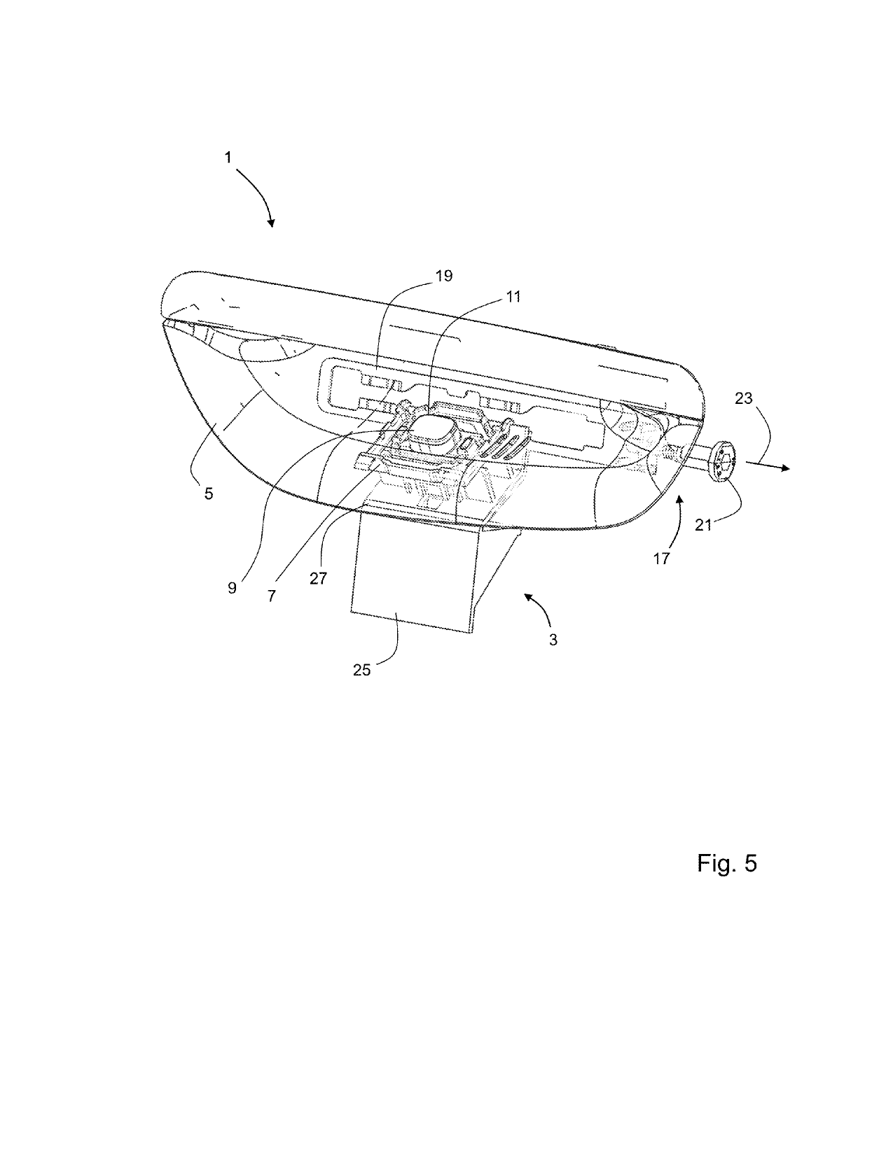

As illustrated in FIGS. 1 to 5, a handle assembly 1, for a vehicle door, comprises a structure part 3 and a cover part 5 arranged to be mounted on the structure part 3.

The handle assembly 1 also comprises a pushing device 7 configured to be mounted on the cover part 5. Said pushing device 7 has a button 9 arranged to be accessible from the exterior of the handle assembly 1 through an opening 11 of the cover part 5, said button 9 being movable between a rest position and a pressed-in position.

The handle assembly 1 also comprises a switching device 13 configured to be mounted on a receiver 14 of the structure part 3. Said switching device 13 includes an actuator 15 configured to be moved from a default position to an actuated position when the cover part 5 is mounted in a final position on the structure part 3, as depicted in the figures, and when the button 9 is displaced from the rest position to the pressed-in position. The button 9 moves the actuator 15 so as to operate it.

The handle assembly 1 also comprises a clearance catch-up system 17 configured to displace the receiver 14 from a retracted position as in FIG. 1, according which the switching device 13 and the receiver 14 are distant from the cover part 5 mounted in a final position, to a deployed position as in FIG. 2, according which the switching device 13 and/or the receiver 14 cooperates with the cover part 5 mounted in final position.

The pushing device 7 and the switching device 13 are two distinct elements that can be handled separately. The pushing device 7 is mounted on the cover part 5 and the switching device 13 is mounted on the structure part 3. The structure part 3 is part of a bracket of the vehicle door.

Thus, an operator has at his disposal on one side the structure part 3 with the switching device 13 already connected to a plug of the vehicle, and, on the other side, the cover part 5 with the pushing device 7.

Then, the operator has to install the cover part 5 in the final position without the need of any connection to be manually done.

The clearance catch-up system 17 can be set in a retracted position when the cover part 5 is being mounted in final position. This provision enables to protect the switching device 13 and to let a sufficient space to install the cover part 5.

At the end of the cover part 5 installation in a final position, the clearance catch-up system 17 can be moved from the retracted position to the deployed to allow the switching device 13 and pushing to cooperate together. In other word, in a deployed position, when the button 9 is pushed, it triggers the switching device 13.

The receiver 14 is in the retracted position when it remains unconstrained by the clearance catch-up system 17.

The clearance catch-up system 17 is in addition configured to maintain the cover part 5 in final position when the receiver 14 is in deployed position.

It appears that the clearance catch-up system 17 has a dual purpose. When the receiver 14 is maintained in deployed position, the cover part 5 cannot be withdrawn from its final position. Once the mounting is completed, all elements of the handle assembly 1 are secured together.

The clearance catch-up system 17 comprises a slider 19 configured to cooperate with a rail made in the structure part 3 between a release position and a fastening position.

The slider 19 is configured to cooperate with the receiver 14 so as to set the receiver 14 in retracted position when the slider 19 is in release position and so as to set the receiver 14 being in deployed position when the slider 19 is in fastening position.

This provision enables to displace the receiver 14 when moving the slider 19. The cover part 5 is configured to cooperate with the slider 19 so as to be maintained in final position by the slider 19 when the slider 19 is in fastening position. When the slider 19 is in the release position, the cover part 5 can be removed or installed on the structure part 3 in the final position.

Then, the slider 19 has a dual purpose. It not only serves as an intermediate element to displace and maintain in position the receiver 14 but also to maintain the cover part 5 in the final position.

The clearance catch-up system 17 comprises an actuating element 21 adapted to move the slider 19 between the release position and the fastening position. Here, said actuating element 21 is a screw that is adapted to fit within a thread of the structure part 3 and/or the slider 19. The screw is arranged to cooperate with the slider 19 so as to displace the slider 19 along the rail. The screw extends in parallel to the rail when fitted within the thread.

The slider 19 presents a cooperation surface configured to cooperate with a complementary surface of the receiver 14 to as to apply a force on the receiver 14 transversally to an extension direction 23 of the rail from the retracted position to the deployed position.

The slider 19 creates a motion transformation as the slider 19 can be displaced according to the rail extension direction 23 whereas the force applied to receiver 14 is transverse to said extension direction 23.

Typically, the cooperation surface presents a curved section extending according to a slope oriented transversally to said extension direction 23. This form biases the receiver 14, which is displaced from the retracted position to the deployed position.

The slider 19 presents at least one bumping surface extending transverse to the extension direction 23 of the rail that is configured to cooperate with a hook or a cage of the cover part 5 when the slider 19 is in fastening position to maintain the cover part 5 in final position.

When the slider 19 is in the release position, the bumping surface is no more in front of the hook or cage and the cover part 5 can be withdrawn by pulling it away transversally to the extension direction 23 of the rail.

The receiver 14 is joined to a base section 25 of the structure part 3, the receiver 14 being movable along a bending line 27 with respect to the base section 25.

The receiver 14 is thus a moving part of the structure part 3 with respect to the base section 25. The movement of the receiver 14 is according to a bending line 27 which implies that the receiver 14 is able to be rotated with respect to the base section 25 around a central axis 29 of the bending line 27.

The central axis 29 is parallel or substantially parallel to the extension direction 23 of the rail. Therefore, the receiver 14 is pivoting with respect to the base section 25 when moving between the retracted position and the deployed position.

The receiver 14 presents at least one stroke limiting rib 31 configured to cooperate with a bearing surface of the base section 25, when the receiver 14 is in retracted position.

The receiver 14 is conceived so as to move in direction of direction of the base section 25 in absence of any force applied on the receiver 14. The bending line 27 is made so as to create an elastic force rotating the receiver 14 towards the base section 25.

The at least one stroke limiting rib 31 enables to stop the rotation of the receiver 14 with respect to the base section 25. It defines the retracted position and also prevents the button 9 and consequently the switching device 13 to be pushed too far.

The receiver 14 has a body 33 extending according to a main plane 35 and at least one leg 37 united with the body 33 and extending transversally to the main plane 35. The at least one leg 37 is configured to cooperate with a mounting interface 39 of the pushing device 7 when the receiver 14 is in the deployed position.

This means that when the receiver 14 is in the retracted position, the at least one leg 37 is distant from the mounting interface 39.

The cooperation between the at least one leg 37 and the mounting interface 39 is realized in such a way to align the button 9 with the actuator 15 for a proper functioning.

This displacement of the receiver 14 between the retracted position and the deployed position does not risk to imply misalignment between the button 9 and the actuator 15.

Indeed, as the at least one leg 37 and is snapped on the mounting interface 39, their respective positions are precisely set when moving the receiver 14 from the retracted position to the deployed position.

The at least one leg 37 and the mounting interface 39 are configured to be snapped together. As an example, the body 33 presents an overall flat shape. Four legs 37 are united with the body 33. There are two stroke limiting ribs 31 which are united with the body 33. The stoke limiting ribs 31 are on the opposite side of the body 33 with respect to the legs 37.

In addition, the receiver 14 includes a bridge 41 configured to cooperate with the slider 19. The bridge 41 is united with the body 33 and is the part of the receiver 14 in contact with the slider 19 so that the slider 19 moves the receiver 14 between the retracted position and the deployed position. Here, the bridge 41 is a flat part which is inclined with respect to the main plane 35.

With this construction it appears that the body 33 and the bridge 41 constitute a flexible tab movable around the central axis 29.

The button 9 is configured to be mounted within the mounting interface 39, the mounting interface 39 being configured to cooperate with the cover part 5 so that the button 9 is accessible from the exterior of the handle assembly 1 to be pushed.

The cover part 5 presents the opening 11 through which the button 9 can be accessed. The mounting interface 39 acts as a support and fixing means for the button 9. The mounting interface 39 with the button 9 mounted on it constitute a sub-assembly that is fixed to the cover part 5 from the interior side of the cover part 5.

The terms “exterior” and “interior” in the present text designate the exterior of the vehicle and the interior of the vehicle or of the handle assembly 1. By “exterior” it is therefore meant that an element is accessible at the end of the mounting by a user from an external side of the vehicle.

Here, the mounting interface 39 is in the interior side and is not visible for the user when the mounting of the handle assembly 1 is complete. The user only sees and have access to the button 9 via the opening 11.

The button 9 is mounted flush with respect to the opening 11. It means that the button 9 presents and end surface for actuation that extends in the continuity of an exterior surface of the cover part 5 or that is slightly lower or higher.

Here, the cover part 5 presents from the exterior a concave shape and consequently from the interior side a convex shape. Such a cover part 5 is also called a “pocket”.

The receiver 14 comprises a at least one clip 43 configured to cooperate with a complementary part of the switching device 13.

This allows to easily fix the switching device 13 on the structure part 3. Preferably, the switching device 13 comprises a housing 45 and at least one contact wire arranged to be connected to a central control system of the vehicle.

The housing 45 comprises the actuator 15 and the at least one contact wire is connected to the actuator 15 and exits the housing 45. Said housing 45 is designed to cooperate with the at least one clip 43.

Said at least one clip 43 is linked to the body 33 of the receiver 14 and extends in parallel or substantially in parallel to the at least one leg 37 on the same side of the receiver 14.

This construction not only enables to assure a correct alignment of the button 9 and the actuator 15 in final position as each elements mounted together are snapped and cooperate by complementary of form, but also it confers a solidity to the button 9 actuator 15 assembly.

In this way, even if the button 9 is pressed by a user with a force that exceed the necessary for actuation, the button 9 and the actuator 15 are maintained in position.

As goes without saying, the invention is not limited to the sole embodiment described above by way of example, it encompasses all the variants.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A handle assembly, for a vehicle door, comprising:
a structure part and a cover part arranged to be mounted on the structure part;
a pushing device configured to be mounted on the cover part, said pushing device having a button arranged to be accessible from an exterior of the handle assembly through an opening of the cover part, said button being movable between a rest position and a pressed-in position;
a switching device configured to be mounted on a receiver of the structure part, said switching device including an actuator configured to be moved from a default position to an actuated position when the cover part is mounted in a final position on the structure part and when the button is displaced from the rest position to the pressed-in position; and
a clearance catch-up system configured to displace the receiver from a retracted position, according which the switching device and the receiver are distant from the cover part mounted in the final position, to a deployed position, according which the switching device and/or the receiver cooperates with the cover part mounted in the final position.

2. The handle assembly according to claim 1, wherein the receiver is in the retracted position when it remains unconstrained by the clearance catch-up system.

3. The handle assembly according to claim 1, wherein the clearance catch-up system is in addition configured to maintain the cover part in the final position when the receiver is in the deployed position.

4. The handle assembly according to claim 1, wherein the clearance catch-up system comprises a slider configured to cooperate with a rail made in the structure part between a release position and a fastening position, the slider being configured to cooperate with the receiver so as to set the receiver in the retracted position when the slider is in the release position and so as to set the receiver being in the deployed position when the slider is in the fastening position.

5. The handle assembly according to claim 4, wherein the slider presents a cooperation surface configured to cooperate with a complementary surface of the receiver to as to apply a force on the receiver transversally to an extension direction of the rail from the retracted position to the deployed position.

6. The handle assembly according to claim 5, wherein the receiver is joined to a base section of the structure part, the receiver being movable along a bending line with respect to the base section.

7. The handle assembly according to claim 6, wherein the receiver or the base section presents at least one stroke limiting rib configured to cooperate with a bearing surface of the base section or respectively with the receiver, when the receiver is in the retracted position.

8. The handle assembly according to claim 7, wherein the receiver has a body extending according to a main plane and at least one leg united with the body and extending transversally to the main plane, the at least one leg being configured to cooperate with a mounting interface of the pushing device when the receiver is in the deployed position.

9. The handle assembly according to claim 8, wherein the button is configured to be mounted within the mounting interface, the mounting interface being configured to cooperate with the cover part so that the button is accessible from the exterior of the handle assembly to be pushed.

10. The handle assembly according to claim 1, wherein the receiver comprises at least one clip configured to cooperate with a complementary part of the switching device.
